(19) United States
(12) Patent Application Publication
(10) Pub. No.: US 2025/0269698 A1
(43) Pub. Date: Aug. 28, 2025

(54) AUTOMATIC DIRECTIONAL CONTROL OF HVAC OUTLETS

(71) Applicant: GM GLOBAL TECHNOLOGY OPERATIONS LLC, Detroit, MI (US)

(72) Inventors: Rupesh Sonu Kakade, West Bloomfield, MI (US); Todd M. Tumas, Grosse Ile, MI (US)

(73) Assignee: GM GLOBAL TECHNOLOGY OPERATIONS LLC, Detroit, MI (US)

(21) Appl. No.: 18/587,679

(22) Filed: Feb. 26, 2024

(51) Int. Cl. B60H 1/00; B60H 1/32

(52) U.S. Cl. CPC B60H 1/00742; B60H 1/00285; B60H 2001/3269

(57) ABSTRACT

A method for automatic directional control of an air conditioning vent including detecting a vehicle location and a vehicle orientation, determining a sun position with respect to the vehicle location and the vehicle orientation, determining a solar heat gain location within a vehicle cabin in response to the sun position, generating a control signal indicative of the solar heat gain location, and positioning the air condition vent to direct an airflow towards the solar heat gain location and to adjust the flow rate of the airflow in response to the control signal.

### INTRODUCTION

The present disclosure relates generally to a system for heating or cooling a vehicle occupant cabin. More specifically, aspects of the present disclosure relate to systems, methods and devices for directing and controlling outlet airflow for climate control systems in response to occupant and sun position.

Many vehicles today have climate control systems, such as one or more heating, ventilation, and air conditioning (HVAC) systems. However, existing techniques may not always provide optimal control of airflow the HVAC under certain conditions. Vents act as the final stage delivery system for the car's system. Engineered for optimal airflow distribution and user control, these vents strategically channel conditioned air throughout the cabin, ensuring thermal comfort and air quality for occupants. The vent are designed to balance air diffusion and directionality. Adjustable louvers, typically controlled by levers or buttons, enable occupants to direct the airflow precisely, maximizing personal comfort. The vent placement plays a crucial role, with strategically positioned outlets at the footwells, dashboard, and rear ensuring uniform temperature distribution and preventing drafts. Additionally, vents are often integrated with the defroster system, directing warm air to the windshield to combat fogging.

Traditionally, vehicle occupants manually adjust the direction and flow rate of the HVAC vents. Adjusting air conditioning vents while driving can introduce several hazards, both immediate and long-term, due to the intricate interplay between driver focus and vehicle dynamics. When a driver takes their eyes off the road to adjust HVAC vents, this inattentiveness can translate into significant distances traveled, increasing the risk of collisions, especially at higher speeds. This is further compounded by the potential distraction of searching for specific vent controls and adjusting them while maintaining vehicle control. Likewise, sudden changes in air direction, especially towards the face, can momentarily obscure vision or induce startle reflexes, potentially leading to swerving or loss of control. This is particularly true for forceful, high-volume air blasts. Additionally, directing air away from the windshield can fog it up, further compromising visibility. Improper vent adjustment can create uncomfortable temperature pockets within the cabin, leading to fatigue and reduced driver alertness. Accordingly, it is desirable to address the aforementioned problems and to provide systems and methods for providing automatic directional control of HVAC outlets for improved occupant thermal comfort. Furthermore, other desirable features and characteristics of the present disclosure will become apparent from the subsequent detailed description and the appended claims, taken in conjunction with the accompanying drawings and the foregoing technical field and background.

The above information disclosed in this background section is only for enhancement of understanding of the background of the invention and therefore it may contain information that does not form the prior art that is already known in this country to a person of ordinary skill in the art.

### SUMMARY

Disclosed herein are vehicle system cooling methods and systems and related control logic for provisioning vehicle heating and cooling systems, methods for making and methods for operating such heating and cooling systems, and motor vehicles equipped with onboard heating and cooling systems. By way of example, and not limitation, there are presented various embodiments of systems for providing automatic directional control of HVAC outlets for improved occupant thermal comfort in a motor vehicle disclosed herein.

In accordance with an aspect of the present disclosure, a heating, ventilation and air conditioning system including a location sensor for detecting a vehicle location and a vehicle orientation, a light sensor for detecting a light intensity, a processor for determining a sun position with respect to the vehicle location and the vehicle orientation, for determining a solar heat gain location in response to the sun position and a vehicle occupant position, and for generating a control signal indicative of the solar heat gain location on the vehicle occupant, and a vent controller for positioning an air conditioning vent in response to the control signal such that an air conditioning airflow is directed towards the solar heat gain location.

In accordance with another aspect of the present disclosure wherein the vent controller is further configured to control a flow rate of the air conditioning airflow in response to the light intensity.

In accordance with another aspect of the present disclosure wherein the vehicle orientation is determined in response to the vehicle location and a prior vehicle location.

In accordance with another aspect of the present disclosure wherein the sun position is determined in response to a current time of day, a current date and the vehicle location.

In accordance with another aspect of the present disclosure wherein the light sensor is a camera having a known field of view with respect to the vehicle orientation and wherein the vehicle orientation is determined in response to the light intensity and the sun position.

In accordance with another aspect of the present disclosure wherein the air conditioning airflow has a flow rate determined in response to the light intensity, a vehicle cabin temperature and a user preference.

In accordance with another aspect of the present disclosure further including a user interface and wherein the sun position is determined in response to a user input requesting an activation of an automatic air conditioning vent directional control algorithm.

In accordance with another aspect of the present disclosure wherein the processor is further operative to determine a solar heat load at the solar heat gain location in response to the light intensity and a vehicle glass light transmission percentage.

In accordance with another aspect of the present disclosure further including a seat sensor for detecting a seat position, a seat recline angle and an occupancy state of a seat and wherein the solar heat gain location is determined in response to the occupancy state of the seat being indicative of a vehicle occupant within the seat, the seat recline angle and the seat position.

In accordance with another aspect of the present disclosure, a method for automatic directional control of an air conditioning vent including detecting a vehicle location and a vehicle orientation, determining a sun position with respect to the vehicle location and the vehicle orientation, determining a solar heat gain location within a vehicle cabin in response to the sun position, generating a control signal indicative of the solar heat gain location, and positioning the air condition vent to direct an airflow towards the solar heat gain location in response to the control signal.

In accordance with another aspect of the present disclosure further including detecting a sunlight intensity, determining a solar heat load at the solar heat gain location and controlling a flow rate of the airflow and a temperature of the airflow in response to the solar heat load.

In accordance with another aspect of the present disclosure wherein the control signal is generated in response to an air conditioning control mode being set to an automatic mode.

In accordance with another aspect of the present disclosure wherein the air conditioning vent is positioned by controlling a position of at least one vent flap and at least one deflector vane.

In accordance with another aspect of the present disclosure wherein the vehicle location is determined in response to a current data from a global positioning system and wherein the vehicle orientation is determined in response to the current data and a previous data from the global positioning system.

In accordance with another aspect of the present disclosure wherein the sun position is determined in response to the vehicle location, a current time of day and a current date.

In accordance with another aspect of the present disclosure further including detecting a first light intensity by a first vehicle camera having a first field of view and a second light intensity by a second vehicle camera having a second field of view and wherein the sun position is determined in response to the first light intensity being greater than the second light intensity.

In accordance with another aspect of the present disclosure including estimating a solar heat load at the solar heat gain location and controlling a flow rate of the airflow and a temperature of the airflow in response to the solar heat load and a user preference.

In accordance with another aspect of the present disclosure wherein the solar heat gain location is defined by a position within a coordinate system centered within the vehicle cabin.

In accordance with another aspect of the present disclosure, a system of implementing an automatic directional control of a vehicle air conditioning vent including a location sensor for detecting a vehicle location and a vehicle orientation of a vehicle, a light sensor for detecting a sunlight intensity, a seat sensor for detecting an occupant with a vehicle seat, an air conditioning vent controller for controlling a direction of an airflow from an air conditioning vent in response to a control signal, and a processor for calculating a sun position with respect to the vehicle in response to a time of day, a date, the vehicle location and the vehicle orientation, for determining a solar heat gain location in response to the sun position and a detection of the occupant within the vehicle seat, and for coupling the control signal indicative of the direction of the airflow to the air conditioning vent controller such that the airflow is directed towards the solar heat gain location from the air conditioning vent.

In accordance with another aspect of the present disclosure wherein the processor is further operative for determining a solar heat load at the solar heat gain location and wherein a flow rate of the airflow and a temperature of the airflow are controlled in response to the solar heat load.

### BRIEF DESCRIPTION OF THE DRAWINGS

The exemplary embodiments will hereinafter be described in conjunction with the following drawing figures, wherein like numerals denote like elements, and wherein:

FIG. 1 shows an application for the method and apparatus for implementing automatic directional control of HVAC outlets in a motor vehicle according to an exemplary embodiment of the present disclosure.

FIG. 2 shows a block diagram of an exemplary system for implementing automatic directional control of HVAC outlets in a motor vehicle according to an exemplary embodiment of the present disclosure.

FIG. 3 shows a flow chart illustrating a method for implementing automatic directional control of HVAC outlets in a motor vehicle according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

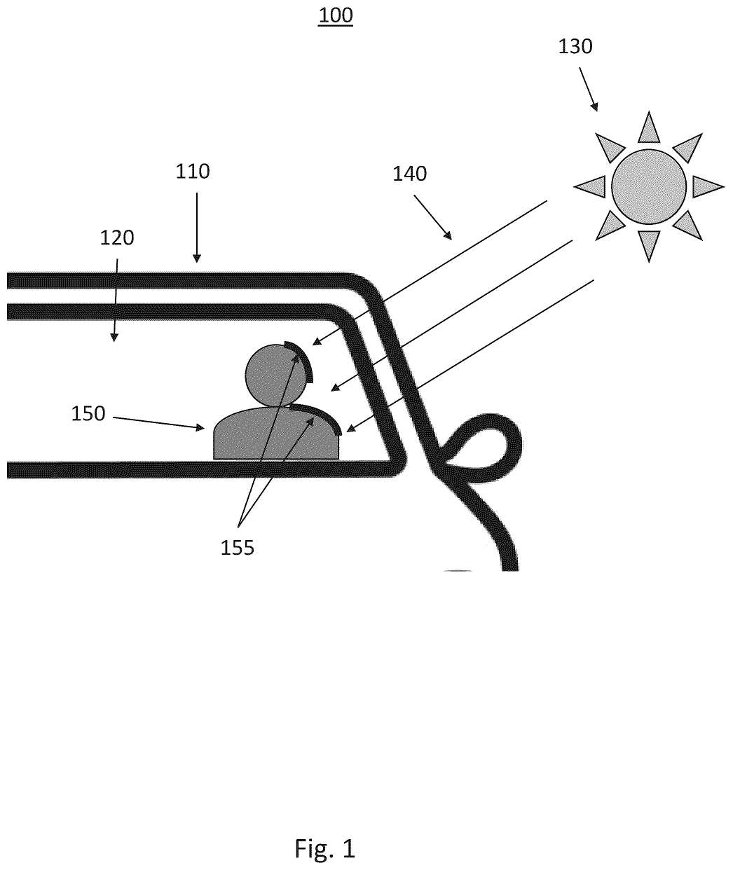

Turning now to FIG. 1, an exemplary environment 100 for implementing automatic directional control of HVAC outlets in a motor vehicle according to an exemplary embodiment of the present disclosure is shown. The exemplary environment 100 is illustrative of a vehicle 110, including windows 120, wherein the vehicle 110 is exposed to the sun 130 such that solar radiation 140 enters the vehicle cabin through the windows 120 and is incident on the vehicle occupant 150. The solar radiation 140 generates solar heat gain locations 155 where the solar radiation 140 is incident on the vehicle occupant 150.

In various embodiments, the vehicle 110 includes an automobile. The vehicle 110 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 110 may also comprise a motorcycle or other vehicle, such as aircraft, spacecraft, watercraft, and so on, and/or one or more other types of mobile platforms (e.g., a robot and/or other mobile platform).

In the exemplary environment 100, the vehicle occupant 150 is exposed to the solar radiation 140 travelling through the vehicle glass 120. The solar radiation 140 creates solar heat gain locations 155 on the vehicle occupant 150 where the solar radiation 140 is incident on the vehicle occupant 150. The exemplary HVAC system is configured such that the aiming of the electronically steerable HVAC outlets is adjusted to target the solar heat gain locations 155 and can adjust an amount of airflow through the electronically steerable HVAC outlets to maintain thermal comfort for the vehicle occupant 150.

It is desirable to enable automatic adjustment to the aiming of the HVAC outlets and the amount of air flow from the HVAC outlets depending on the directional solar load on the vehicle occupant 150 to maintain the desired thermal comfort level for the vehicle occupant 150. Automatic aiming of the HVAC outlets and adjustment of HVAC air flow to maintain thermal comfort of the vehicle occupant 150 reduces the need for the vehicle occupant 150 to adjust the outlets manually to direct more or less air flow onto the solar heat gain locations 155 exposed to the direct solar radiation 140.

The exemplary HVAC system can perform a method to determine the automatic aiming of the HVAC outlets, such as in a cartesian coordinate system, and the rate or the amount of air flow from the HVAC outlets is described. The automatic adjustments are made depending on the directional solar load onto the vehicle occupant 150 at solar heat gain locations 155 from all openings of the vehicle cabin. Openings including fixed glass areas such as the front windshield and roof glass, and movable glass areas such as the door windows, backlite, and sunroof or moonroof glass. Additional openings include removable top of the convertible vehicles, sliding doors of the delivery vans, etc. The proposed adjustments to the aiming and air flow or velocity are performed to maintain the user selected thermal comfort level for each vehicle occupant (i.e., for each seating position). Further, the adjustment to the aiming of the HVAC outlets can be performed based on the seat's vertical and horizontal position and also based on the recline angle of the seat.

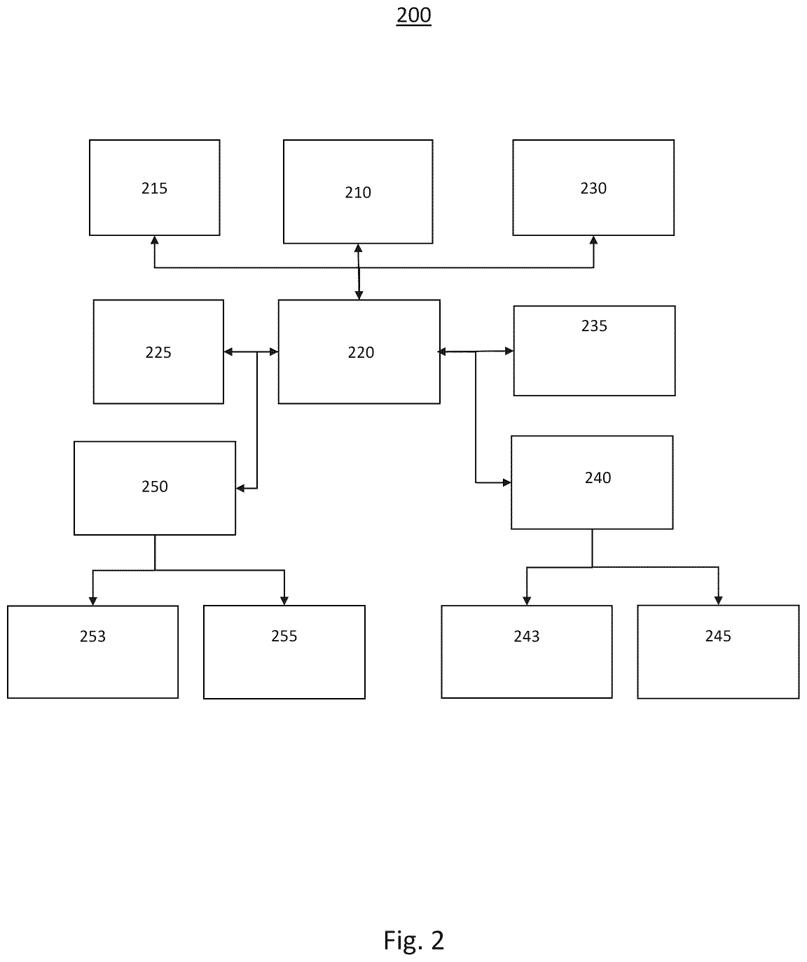

Turning now to FIG. 2, an exemplary system 200 for implementing automatic directional control of HVAC outlets in a motor vehicle according to an exemplary embodiment of the present disclosure is shown. The exemplary system 200 can include an optical sensor 210, a global navigation satellite system (GNSS) 215, a processor 220, a user interface 230, a seat sensor 225, a temperature sensor 235, a thermal controller 240, a heating circuit 243, a cooling circuit 245, a vent controller 250, a first vent 253 and a second vent 255.

The exemplary system 200 for implementing automatic directional control of HVAC outlets can be operative in several configurable modes such as the diffused mode, the concentrated mode, the oscillation mode, and the auto mode. The auto mode can be used to maintain thermal comfort of the occupants and will adjust aiming and air flow volume of the HVAC vents 253, 254 to increase or decrease cooling of the body parts based on the directional solar heat load for each vehicle occupant independently. The system is configured to predict areas of solar heat gain on one or more vehicle occupants and to automatically direct and configured HVAC vents 253, 254 to focus cooling on those areas to improve occupant thermal comfort. The areas of solar heat gain can be predicted by determining an angle of incidence of solar radiation with respect to the vehicle, location of vehicle windows, and the occupant's position within the vehicle cabin.

In some exemplary embodiments, the angle of incidence of the solar radiation can be predicted in response to one or more optical sensors to detect light intensity and direction, vehicle orientation, weather conditions and predicted sun azimuth and altitude. The optical sensor 210 is operative to convert light into an electrical signal. When light hits the optical sensor 210, the light is absorbed by a material that produces an electrical current. The amount of current produced is proportional to the intensity of the light. Examples of electrical sensors can include photodiodes, phototransistors, charge coupled devices (CCDs), and complementary metal-oxide-semiconductor (CMOS). One or more optical sensors 210 can be employed in the exemplary system 200 in order to detect an intensity of light within a vehicle cabin and/or a direction of a light source. The processor 220 can be operative to estimate a sunlight intensity on the vehicle indicative of direct sun exposure of the vehicle in response to an output from the optical sensor 210 and/or in response to a GNSS signal from the GNSS 215 and time, date and vehicle orientation data. The processor 220 may be further operative to monitor the outside temperature, interior temperature, light intensity and time of day in order to engage or disengage the automatic directional control of the HVAC outlets 253, 255 if they are no longer required or to change the focus of the HVAC outlets 253 as the vehicle moves and rotates relative to the position of the sun.

The processor 220 can be used to calculate the angle of incidence of the solar radiation using the sun elevation angle and sun azimuth angle for a particular location, time and vehicle orientation. The angle of incidence of the solar radiation is then combined with the cabin geometry information, which can be defined in a 3-dimensional Cartesian coordinate system, or a spherical coordinate system, to calculate the location and area of exposure of the occupant's body to the direct sunlight passing through the glass or openings of the vehicle cabin. The exposure to the direct sunlight can be calculated for all occupants and from all openings of the cabin.

Once the angle of incidence of the solar radiation is mapped to the coordinate system centered on the vehicle cabin, the processor 220 next determines locations for the vehicle occupants. Seat sensors 225 can be used to detect if a seat within the vehicle is occupied. The seat sensors 225 can include pressure sensors mounted within the seat cushion, thermal detection imaging, and the like. The seat sensors 225 can further detect seat information such as seat position, recline angle, etc. This information can then be coupled to the processor 220 for estimation of a location of an occupant and mapping of that location within the coordinate system. The processor 220 is next operative for determining solar heat gain locations for each of the vehicle occupants and/or other vehicle interior surfaces.

The processor 220 can employ ray tracing methods to determine the area of solar radiation exposure for each occupant to the solar radiation that is passing through one or multiple openings of the cabin. These solar heat gain locations can be weighted by an intensity of the sunlight incident on the occupant location to calculate the directional solar heat load for each occupant. In some exemplary embodiments, to calculate the intensity of the impinging sun light, the measured ambient sun light intensity can be adjusted for any estimated transmission reduction by the vehicle glass, such as for tinted glass. In case of no glass in the opening, such as an open window, no transmission reduction is performed.

Based on the calculated directional solar heat load, aiming of the HVAC vents 253, 254 is performed to concentrate air flow onto the determined solar heat gain locations for each of the vehicle occupants and/or other vehicle interior surfaces. Additionally, the amount of air flow can be increased to provide more cooling to the high solar heat gain locations and reduced in cabin locations without additional solar heat gain. Increased cooling of solar heat gain locations, such as cooling of interior vehicle surfaces, has the added benefit of reduced radiated heat from those locations, resulting in a lower overall vehicle cabin temperature.

The exemplary system 200 can further include a user interface 230, such as a display, a light emitting diode, and/or user input, such as a button or touch screen. This user interface 230 can be used to indicate to a vehicle occupant that the auto cooling algorithm has been initiated. The user interface 230 can indicate to the occupant the current heating or cooling level of the HVAC system and provide a means for the occupant to adjust this temperature using the user input. The user interface 230 can be configured to allow the occupant to initiate or deactivate the algorithm. In some exemplary embodiments, the user interface 230 can provide visual feedback to a user an initiation or deactivation of the automatic directional control of HVAC vents 253, 255.

In some exemplary embodiments, in response to an occupant adjusting an airflow rate and/or a cooling level of the HVAC system in automatic directional control mode, the system 200 can store these altered airflow rates and/or temperature adjustments in a memory as a preference associated with a particular occupant. For example, the automatic directional control HVAC system can determine a first airflow rate for a particular predicted solar heat load on an occupant and generate control signals to the vent controller 250 to provide the first airflow rate. The occupant can then reduce the airflow rate to a second airflow rate using the user interface 230. The system 200 can then save this second airflow rate in a memory as a default airflow rate for that particular solar heat load for this particular occupant.

In response to the previous determinations, the processor 220 can generate a control signal to activate a heat transfer system including a heating circuit 243 and/or a cooling circuit 245 to provide heated or cooled air to the vehicle cabin via the HVAC vents 253, 255. In some exemplary embodiments, the processor 220 can generate a control signal indicative of the desire temperature and/or temperature control duty cycle and couple this control signal to a thermal controller 240. The thermal controller 240 can then in turn control the heating circuit 243 or cooling circuit 245 to provide conditioned air to the vehicle cabin.

In some exemplary embodiments, the processor 220 can determine a current temperature of the object in response to the output signal from the temperature sensor 235 and can control the heating circuit 243 and/or the cooling circuit 245 to maintain the current temperature or achieve a desired temperature of the object and/or the object contents. The processor 220 can vary at least one of the magnitude of the electrical power provided and the duty cycle of the electrical power provided to the heating circuit 243 and/or the cooling circuit 245 in order to achieve the desired temperature.

The HVAC vents 253, 255 can include vent flaps for directing the conditioned air from the duct towards the desired location within the car cabin and deflector vanes for controlling the direction and spread of the airflow from the vent flaps. In some exemplary embodiments, the vent flaps and deflector vanes are positioned by electric motors in response to control signals generated by the vent controller 250. In some exemplary embodiments, the vent controller 250 can receive a position of the solar heat gain locations within the vehicle cabin from the processor 220. These solar heat gain locations can be identified according to the defined coordinate system. The vent controller 250 can the determine the vent flap and deflector vane orientations such that the airflow of the HVAC vents 253, 255 direct air towards the solar heat gain locations. Furthermore, the processor 220 can transmit data indicative of an air flow rate, and the vent controller 250 can further adjust the HVAC vents 253, 255 orientations to provide the indicated air flow rate to the solar heat gain locations.

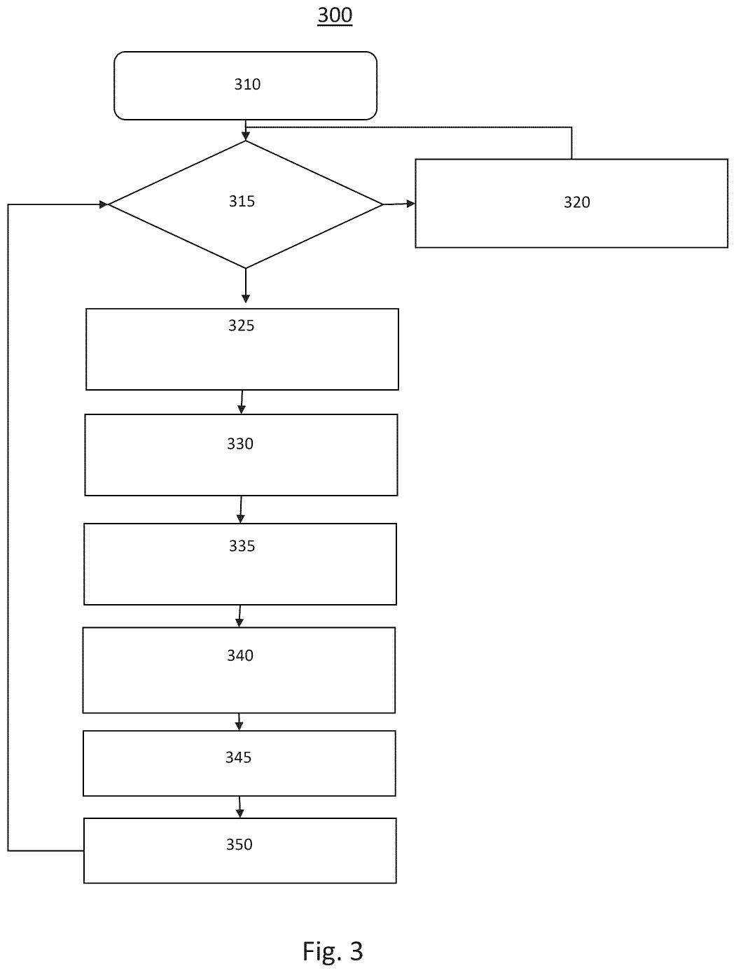

Turning now to FIG. 3, a flow chart illustrating an exemplary method 300 for implementing automatic directional control of HVAC outlets in a motor vehicle according to an exemplary embodiment of the present disclosure is shown. In some exemplary embodiments, the method 300 is first initiated 310. The method 300 can be initiated 310 in response to a vehicle initiation, such as transitioning a vehicle run state between an off state and a standby or on state. Likewise, the method 300 can be initiated 310 in response to an activation of a vehicle HVAC system or other vehicle thermal control system, such as a battery cooler or warming system for electric vehicles.

The method 300 is next configured to determine 315 if the vehicle HVAC system is set to a mode that enables the automatic directional control of the HVAC vents in response to a determination of solar heat gain locations on a vehicle occupant or a vehicle cabin surface. For example, if the HVAC control system is set to an auto mode, the automatic directional control can be enabled. If the HVAC control system is set to a manual mode, or a mode where the automatic directional control can be disabled. If the automatic directional control is not enabled 315, the method 300 controls the HVAC setting according the current manual HVAC settings 320 for the HVAC system. In some exemplary embodiments, these current manual HVAC settings can be default settings, settings generated by an alternative HVAC algorithm, such as a defrost mode, or settings determined in response to a user input on a user interface. The method 300 returns to determining if the automatic directional control is enabled 315.

If the automatic directional control is enabled 315, the method 300 next determines a vehicle position and orientation 325. The vehicle position can be determined in response to GNSS data or other available vehicle location data, such as data from other wireless sources, such as mobile phone networks, user devices or the like. The vehicle orientation can be determined in response to a determination of a plurality of periodically determined vehicle locations indication a direction of travel and therefore a vehicle orientation. Once the vehicle location and orientation are determined, the method 300 next determines a sun position 330 with respect to the vehicle location and orientation. The sun position is predictable and can be determined in response to date and time of day and vehicle location. The method can then determine sunlight intensity and directional angles of the direct sun light in response to the sun position. The directional angles of the sunlight can be defined according to the vehicle coordinate system, where the vehicle coordinate system is oriented with respect to the vehicle. The sunlight intensity can be determined in response to light sensors or cameras within or outside of the vehicle.

The method 300 next determines solar heat gain locations 335 within the vehicle cabin in response to the angles of direct sunlight and sunlight intensity. In some exemplary embodiments, the solar heat gain locations can be determined with respect to vehicle occupant positions, seat positions and seat recline positions. The solar heat gain locations are locations within the vehicle cabin and on vehicle occupants that are exposed to direct sunlight, thereby experiencing an increased solar heat load from the incident sunlight. The solar heat gain locations can be defined by locations within the vehicle coordinate system. In some exemplary embodiments, the method can calculate the area of exposure of the occupant's body parts to the direct sunlight passing through each of the vehicle cabin glass, by using a ray tracing method. Repeat the calculation of area of exposure for all vehicle occupants. Likewise, the intensity of the sunlight impinging on the occupants can be calculated based on the ambient sunlight intensity and the transmission reduction by the vehicle glasses. Each vehicle glass or opening into the vehicle cabin can have unique or separate sunlight transmission properties. In some exemplary embodiments, similar glasses such as front door glasses, left and right, can be assumed to share the sunlight transmission properties.

In response to the determined solar heat gain locations and the sunlight intensity, the method 300 can next generate control signals indicative of the solar gain locations, airflow rates and HVAC temperature settings. These control signals can be coupled to HVAC vent position controllers, HVAC fan controllers, and HVAC thermal controllers. The controllers are then operative to control the HVAC air temperature 345 according to the desired air temperature. The HVAC fan controllers 350 and HVAC vent positions controllers are operative to control positioning 350 of the HVAC vent flaps and/or deflector vanes such that the airflow is directed towards the solar heat gain locations according to the desired airflow rate. Thus, the various controllers can be configured to adjust the aiming of the HVAC vents to direct the air flow onto the body parts that are exposed to the direct sunlight. Additionally, the various controllers adjust the amount of air flow from the air conditioning outlets based on the solar heat onto the exposed body parts such that the air flow is increased when the solar heat is high. The exemplary method 300 can further be configured to provide an adaptive rate air flow for vehicle occupants based on previously determined preferences. If a vehicle occupant has a sensitivity to direct airflow, the method 300 can lower the rate of airflow while still getting the benefit of direct cooling. Once the method 300 has directed the airflow towards the solar load locations and controlled the temperature and flowrate of the airflow, the method 300 returns to determining if the automatic airflow directional control is enabled 315.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A heating, ventilation and air conditioning system comprising:
a location sensor for detecting a vehicle location and a vehicle orientation;
a light sensor for detecting a light intensity;
a processor for determining a sun position with respect to the vehicle location and the vehicle orientation, for determining a solar heat gain location in response to the sun position and a vehicle occupant position, and for generating a control signal indicative of the solar heat gain location; and
a vent controller for positioning an air conditioning vent in response to the control signal such that an air conditioning airflow is directed towards the solar heat gain location.

2. The heating, ventilation and air conditioning system of claim 1 wherein the vent controller is further configured to control a flow rate of the air conditioning airflow in response to the light intensity.

3. The heating, ventilation and air conditioning system of claim 1 wherein the vehicle orientation is determined in response to the vehicle location and a prior vehicle location.

4. The heating, ventilation and air conditioning system of claim 1 wherein the sun position is determined in response to a current time of day, a current date and the vehicle location.

5. The heating, ventilation and air conditioning system of claim 1 wherein the light sensor is a camera having a known field of view with respect to the vehicle orientation and wherein the vehicle orientation is determined in response to the light intensity and the sun position.

6. The heating, ventilation and air conditioning system of claim 1 wherein the air conditioning airflow has a flow rate determined in response to the light intensity, a vehicle cabin temperature and a user preference.

7. The heating, ventilation and air conditioning system of claim 1 further including a user interface and wherein the sun position is determined in response to a user input requesting an activation of an automatic air conditioning vent directional control algorithm.

8. The heating, ventilation and air conditioning system of claim 1 wherein the processor is further operative to determine a solar heat load at the solar heat gain location in response to the light intensity and a vehicle glass light transmission percentage.

9. The heating, ventilation and air conditioning system of claim 1 further including a seat sensor for detecting a seat position, a seat recline angle and an occupancy state of a seat and wherein the solar heat gain location is determined in response to the occupancy state of the seat being indicative of a vehicle occupant within the seat, the seat recline angle and the seat position.

10. A method for automatic directional control of an air conditioning vent comprising:
detecting a vehicle location and a vehicle orientation;
determining a sun position with respect to the vehicle location and the vehicle orientation;
determining a solar heat gain location within a vehicle cabin in response to the sun position;
generating a control signal indicative of the solar heat gain location; and
positioning the air condition vent to direct an airflow towards the solar heat gain location in response to the control signal.

11. The method for automatic directional control of the air conditioning vent of claim 10 further including detecting a sunlight intensity, determining a solar heat load at the solar heat gain location and controlling a flow rate of the airflow and a temperature of the airflow in response to the solar heat load.

12. The method for automatic directional control of the air conditioning vent of claim 10 wherein the control signal is generated in response to an air conditioning control mode being set to an automatic mode.

13. The method for automatic directional control of the air conditioning vent of claim 10 wherein the air conditioning vent is positioned by controlling a position of at least one vent flap and at least one deflector vane.

14. The method for automatic directional control of the air conditioning vent of claim 10 wherein the vehicle location is determined in response to a current data from a global positioning system and wherein the vehicle orientation is determined in response to the current data and a previous data from the global positioning system.

15. The method for automatic directional control of the air conditioning vent of claim 10 wherein the sun position is determined in response to the vehicle location, a current time of day and a current date.

16. The method for automatic directional control of the air conditioning vent of claim 10 further including detecting a first light intensity by a first vehicle camera having a first field of view and a second light intensity by a second vehicle camera having a second field of view and wherein the sun position is determined in response to the first light intensity being greater than the second light intensity.

17. The method for automatic directional control of the air conditioning vent of claim 10 including estimating a solar heat load at the solar heat gain location and controlling a flow rate of the airflow and a temperature of the airflow in response to the solar heat load and a user preference.

18. The method for automatic directional control of the air conditioning vent of claim 10 wherein the solar heat gain location is defined by a position within a coordinate system centered within the vehicle cabin.

19. A system of implementing an automatic directional control of a vehicle air conditioning vent comprising:
a location sensor for detecting a vehicle location and a vehicle orientation of a vehicle;
a light sensor for detecting a sunlight intensity;
a seat sensor for detecting an occupant with a vehicle seat;
an air conditioning vent controller for controlling a direction of an airflow from an air conditioning vent in response to a control signal; and
a processor for calculating a sun position with respect to the vehicle in response to a time of day, a date, the vehicle location and the vehicle orientation, for determining a solar heat gain location in response to the sun position and a detection of the occupant within the vehicle seat, and for coupling the control signal indicative of the direction of the airflow to the air conditioning vent controller such that the airflow is directed towards the solar heat gain location from the air conditioning vent.

20. The system of implementing the automatic directional control of the vehicle air conditioning vent of claim 19 wherein the processor is further operative for determining a solar heat load at the solar heat gain location and wherein a flow rate of the airflow and a temperature of the airflow are controlled in response to the solar heat load.
